(19) United States
(12) Patent Application Publication
(10) Pub. No.: US 2008/0162814 A1
(43) Pub. Date: Jul. 3, 2008

(54) Devices and Methods of Operating Memory Devices Including Power Down Response Signals

(75) Inventor: Gwang Myung Kim, Suwon-si (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/845,280

(22) Filed: Aug. 27, 2007

(30) Foreign Application Priority Data
Jan. 3, 2007 (KR) 2007-0000556

(51) Int. Cl. G06F 12/16

(52) U.S. Cl. 711/115; 711/E12.103

(57) ABSTRACT

A method of operating a storage device can include transferring system data generated by a controller circuit, in the storage device, to a non-volatile memory unit, in the storage device, responsive to a power down signal received from a host outside the storage device and power down response signal transmitted by the storage device. Related devices and systems are also disclosed.

### CROSS-REFERENCE TO RELATED PATENT APPLICATION

This application claims priority under 35 U.S.C. § 119 from Korean Patent Application No. 10-2007-0000556, filed on Jan. 3, 2007, the disclosure of which is hereby incorporated by reference herein as if set forth in its entirety.

### FIELD OF THE INVENTION

The present invention relates generally to the field of semiconductor memories, and more particularly, to power down sequencing for semiconductor memory devices.

### BACKGROUND

Semiconductor memory devices (e.g., memory cards), in general, are widely used as a data storage devices in various digital electric devices such as a PC, personal digital assistants (PDAs), a digital still camera, a mobile phone, a MP3 player, etc. By using non-volatile semiconductor memory devices such as a flash EEPROM, it has the advantage of keeping memory contents from being erased, even when power is off, as well as, its physical attributes of small size, light weight and high performance.

When data (hereinafter ‘user data’) transferred by a host (e.g., digital electric devices) is stored in a memory unit such as a flash EEPROM of the memory card. A controller embodied in the memory card can generate system data based on the user data and can store the generated system data in the memory unit.

The time needed to process the user and system data in a memory unit can be a factor in the performance of the memory card, therefore, shorter storage time for the user data and the system data may provide improved performance of the memory card.

The system data can be signals generated from the user data and information used to control the memory card. For example, the system data can include information about bad blocks among memory blocks formed in the memory card and information about new address mapping when the bad block occurs.

It is known that when some memory cards successively receive a first user data and a second user data from a host, a controller of the memory card stores the first user data in a memory unit, generates a first system data based on the first user data, and stores the generated first system data in the memory unit.

Also, the controller stores the second user data, which are input following the first user data, in the memory unit of the memory card, generates a second system data based on the second user data, and stores the generated second system data in the memory unit. The host may stop the use of the memory card (e.g., power down) after the second user data is stored in the memory card, so that power supplied to the memory card may be removed before the second system data is generated or completely stored in the memory unit.

It is known that the controller can store every generated system data in the memory unit when the controller receives the user data, so that it may result in a longer time to store the whole data.

### SUMMARY

Embodiments according to the invention can provide devices and methods of operating memory devices including power down response signals. Pursuant to the embodiments, a method of operating a storage device can include transferring system data generated by a controller circuit, in the storage device, to a non-volatile memory unit, in the storage device, responsive to a power down signal received from a host outside the storage device and power down response signal transmitted by the storage device.

In some embodiments according to the invention, a method of operating a memory card using a remote host includes transmitting a power down signal to the memory card and then removing power to the memory card in response to a power down response signal received from the memory card.

In some embodiments according to the invention, a semiconductor memory device includes a volatile memory unit that is configured to store system data during operation of the semiconductor memory device. A CPU is connected to the volatile memory unit and is configured to generate a system data storage control signal in response to a power down signal received from a host. A data control circuit is connected to the CPU and is configured to transfer the system data from the volatile memory unit to a non-volatile memory unit responsive to the data storage control signal, wherein the CPU transmits a power down response signal to the host upon completion of transferring the system data to the non-volatile memory unit.

In some embodiments according to the invention, a semiconductor memory device includes a non-volatile memory unit and a controller circuit, connected to the non-volatile memory unit, that is configured to transfer system data to the non-volatile memory unit in response to a power down signal received from a host, wherein the controller circuit transmits a power down response signal to the host upon completion of transferring the system data to the non-volatile memory unit.

In some embodiments according to the invention, an electric device includes a host control unit that is configured to control data input/output to/from a memory card coupled thereto, and is configured to transmit a power down signal to the memory card. A power controller circuit is configured to selectively provide power to the memory card, wherein the host control unit is configured to transmit a power down control signal to the power controller circuit in response to a power down response signal received from the memory card after transmission of the power down signal, wherein the power controller circuit is further configured to remove power from the memory card responsive to the power down control signal.

In some embodiments according to the invention, a power down method of an electric system includes transmitting a power down signal from a host to a memory card, storing system data in a non-volatile memory unit in response to the power down signal from the host, transmitting a power down response signal to the host upon completion of storing the system data in the non-volatile memory unit, and removing power supplied to the memory card based on the power down response signal.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention.

FIG. 1 is a block diagram of electric system according to an example embodiment of the present invention;

FIG. 2A through FIG. 2J illustrates electric devices respectively including the electric system illustrated in FIG. 1;

FIG. 3 is a flowchart illustrating powering down of the semiconductor memory devices in some embodiments according to the invention;

FIG. 4 is a flowchart illustrating powering down of the semiconductor memory devices in some embodiments according to the invention;

FIG. 5 is a flowchart illustrating powering down of the semiconductor memory devices in some embodiments according to the invention; and

FIG. 6 is a flowchart illustrating powering down of the semiconductor memory devices in some embodiments according to the invention;

### DESCRIPTION OF EMBODIMENTS ACCORDING TO THE INVENTION

The invention now will be described more fully hereinafter with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention. The term “directly” means that there are no intervening elements. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that some structures having functional names described herein, such as CPU, controller or control, memory, etc. can be embodied as circuits or a combination of software and circuits.

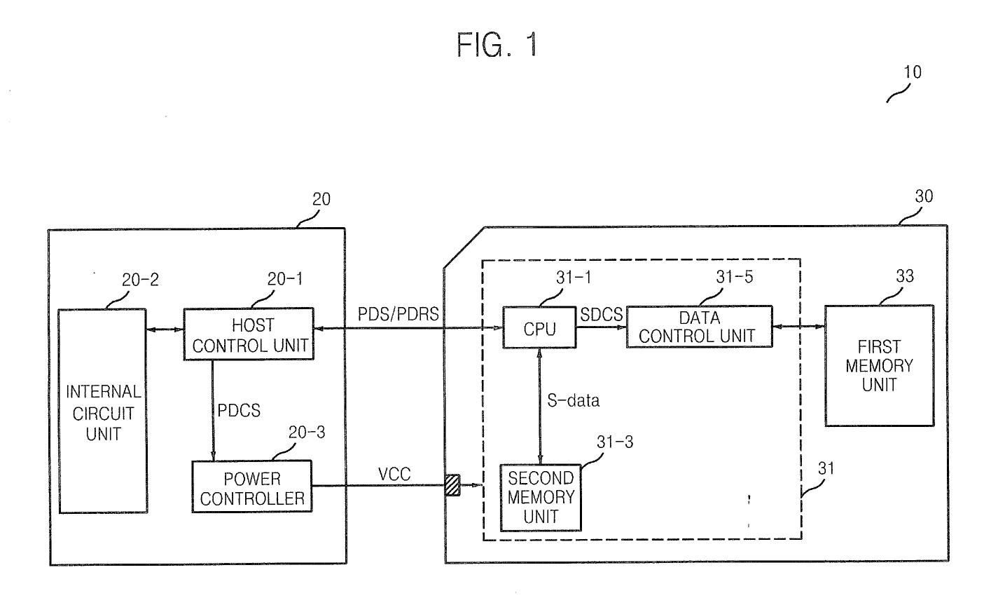

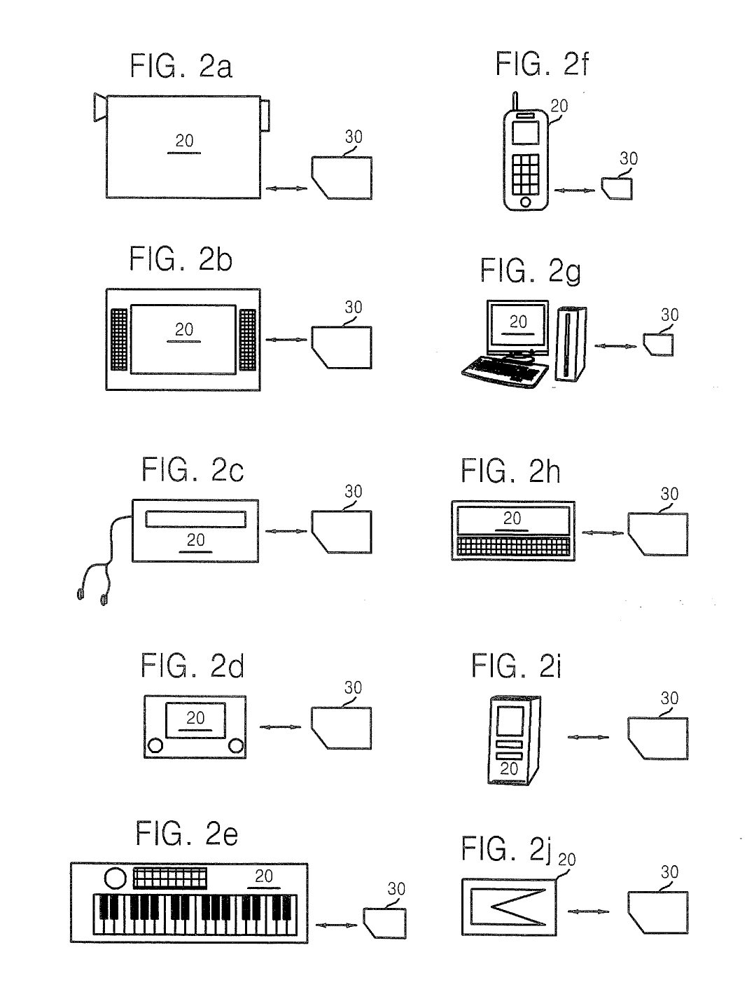

FIG. 1 is a block diagram that illustrates electric systems in some embodiments according to the present invention, and FIG. 2A through FIG. 2J illustrates electric devices including the electric system of FIG. 1. Referring to FIGS. 1 and 2A through 2J, electric system 10 includes a host 20 and a semiconductor memory device 30. The electric system 10 may be embodied in a video camera of FIG. 2A, a television of FIG. 2B, a MP3 of FIG. 2C, a game instrument of FIG. 2D, an electric musical instrument of FIG. 2E, a portable terminal of FIG. 2F, a personal computer PC of FIG. 2G, a personal digital assistant (PDA) of FIG. 2H, a voice recorder of FIG. 2I, or a PC card of FIG. 2J.

The host 20 includes a host control unit 20-1, an internal circuit unit 20-2, and a power controller 20-3. The host control unit 20-1 controls data input/output between the internal circuit unit 20-2 and a semiconductor memory device 30 (e.g., a memory card) and transmits a power down signal PDS to the memory card 30.

The power down signal PDS is a signal indicating that power supplied from the power controller 20-3 to the semiconductor memory device 30 is to be removed. The host control unit 20-1 transmits a power down control signal PDCS to the power controller 20-3 in response to receiving a power down response signal PDRS from the semiconductor memory device 30 (indicating that system data transfer is complete and that it is safe to remove power from the semiconductor memory device 30). The internal circuit unit 20-2 may generate user data, output, or display data stored in the semiconductor memory device 30.

For example, when the host 20 is a video camera of FIG. 2A, the internal circuit unit 20-2 may include a CMOS image sensor CIS, an image processor, and a digital signal processing unit, and transmit data generated in the internal circuit unit 20-2 (e.g., image data or audio data) through a card interface (not shown) to the semiconductor memory device 30.

The power controller 20-3 is a device that selectively supplies a power voltage VCC to the semiconductor memory device 30. It may remove the power VCC supplied to the semiconductor memory device 30 in response to a power down control signal PDCS generated by the host control unit 20-1. The power voltage VCC is a voltage supplied to a CPU 31-1, a second memory unit 31-3, a data control unit 31-5, and/or a first memory unit 33 for the operation of the semiconductor memory device 30.

The semiconductor memory device 30 electrically connected to a memory slot (not shown) may store data (e.g., image data or audio data) output from the internal circuit unit 20-2 through a card interface (not shown) embodied in the host 20, or transmit stored data to the internal circuit unit 20-2. The semiconductor memory device 30 may include a power supply terminal input pin receiving a power voltage VCC from the host, an address pin receiving addresses of data, a data input/output pin receiving data, and a command pin receiving various commands, etc.

Also, the semiconductor memory device 30 may be a memory card, a compact flash, a memory stick, memory stick duo, a multimedia card (MMC), a diminutive MMC, a secure digital (SD) card, a mini SD card, a micro SD card (transflash), a smartmedia card and a XD-picture card, etc. The semiconductor memory device 30 includes a controller 31 (or controller circuit) and a first memory unit 33 (which may be in some embodiments according to the invention, a nonvolatile memory). The controller 31 includes a CPU 31-1, a second memory unit 31-3 (which may be in some embodiments according to the invention, a nonvolatile memory) and a data control unit 31-5.

The CPU 31-1 is connected between the second memory unit 31-3 and the data control unit 31-5, and is configured to generate a system data storage control signal SDCS to the data control unit 31-5 in response to the power down signal PDS received from the host 20, and to transmit the power down response signal PDRS to the host 20 when the transfer of system data S-data to the first memory unit 33 is complete.

For example, the CPU 31-1 may generate the system data storage control signal SDCS in response to the power down signal PDS and transmit the power down response signal PDRS to the host 20 in response to a signal occurring when the system data S-data output from the second memory unit 31-3 are completely stored in the first memory unit 33.

In some embodiments according to the invention, the host 20, therefore, does not remove power from the semiconductor memory device 30 until receiving a power down response signal PDRS from the CPU 31-1, so that the system data S-data output from the second memory unit 31-3 can be safely stored in the First memory unit 33 before power is removed.

Further, in some embodiments according to the present invention, the CPU 31-1 uses additional second memory unit 31-3 to store the system data S-data and transfers the system data S-data from the second memory unit 31-3 to the first memory unit 33 when closing a system (i.e., when a power down signal PDS is received), so that it may reduce the whole data storage time.

In some embodiments according to the invention, the CPU 31-1 transmits user data from the host 20 to the first memory unit 33 through a data control unit 31-5, and generates the system data S-data based on the user data. The system data S-data are data generated based on the user data, and also information for managing data of the semiconductor memory device 30. For example, the system data S-data includes information for a bad block among memory blocks formed in the first memory unit 33 or information for new address mapping when the bad block occurs.

In some embodiments according to the invention, the CPU 31-1 transmits the system data S-data to the second memory unit 31-3, updates the system data S-data based on user data, which are inputted next, and transmits the updated system data S-data to the second memory unit 31-3.

It will be understood that the term “transfers” or “transferring” refers to relocating data from one memory to another (i.e. from the nonvolatile memory unit to the nonvolatile memory unit). Accordingly, in some embodiments according to the invention, transferring system data can be accomplished by the CPU accessing the data in the volatile memory unit 31-3 and transferring the system data to the nonvolatile memory unit 33. In alternative embodiments according to the invention, the system data can be transferred via direct access by the data control unit 31-5 to the nonvolatile memory unit 31-3 and to the nonvolatile memory unit 33.

The second memory unit 31-3 connected to the CPU 31-1 receives and stores the system data S-data. The second memory unit 31-3 receives and stores successively the system data S-data generated in the CPU, so that it can be embodied as a volatile memory. And the volatile memory may be a synchronous random access memory SRAM or a dynamic random access memory DRAM.

In some embodiments credit to the invention, the data control unit 31-5 connected to the CPU 31-1 reads the system data S-data, which are stored in the second memory unit 31-3 in response to the system data storage control signal SDCS generated from the CPU 31-1, through the CPU 31-1 and transmits the accessed system data S-data to the first memory unit 33.

In addition, in some embodiments according to the present invention, data control unit 31-5 may directly read the system data S-data stored in the second memory unit 31-3 and transmit them to the first memory unit 33.

The first memory unit 33 receives and stores user data from the data control unit 31-5. And the first memory unit 33 stores the system data S-data stored in the second memory unit 31-3 in response to the power down signal PDS output from the host 20.

The first memory unit 33 can be embodied as a non-volatile memory such as a Mask ROM, an Electrically Erasable and Programmable Read Only Memory EEPROM or an Erasable and Programmable Read Only Memory EPROM, etc.

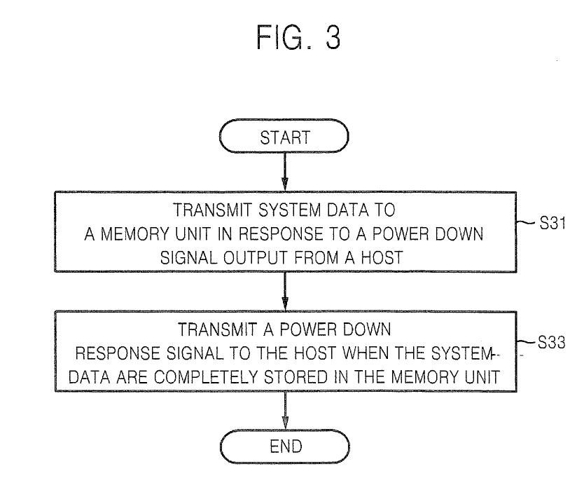

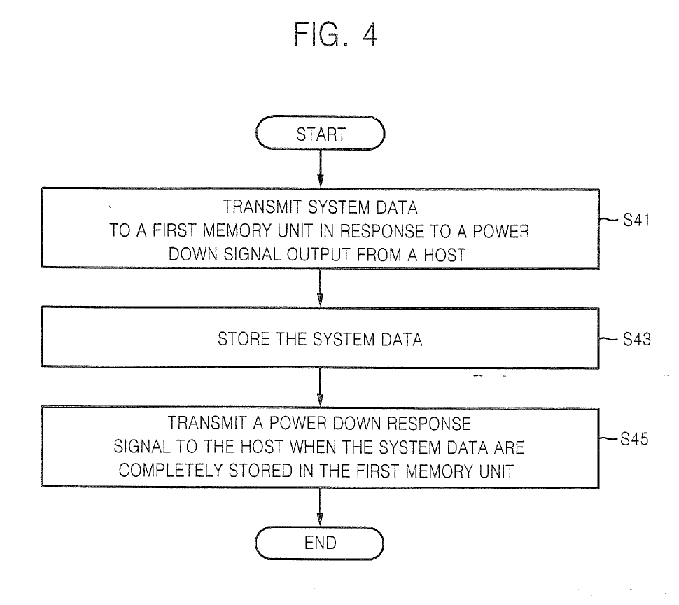

FIGS. 3 and 4 are flowcharts that illustrate methods of providing power to a semiconductor memory device according to exemplary embodiments of the present invention. Referring to FIGS. 1 and 3 through 4, power down methods associated with a semiconductor memory device illustrated in FIG. 3 illustrate power down methods of a controller 31 when the semiconductor memory device is the controller 31. The controller 31 transmits system data S-data stored in a second memory unit 31-3 to the first memory unit 33 in response to a power down signal PDS output from the host 20 (S31).

The controller 31 transmits a power down response signal PDRS to the host 20 when the storage of the system data S-data in the first memory unit 33 is completed (S33), and the host 20 power down power supplied to the controller 31 based on a power down response signal PDRS.

A power down method of a semiconductor memory device illustrated in FIG. 4 displays a power down method of the memory card 30 when the semiconductor memory device is a memory card 30. The controller 31 transmits system data S-data stored in the second memory unit 31-3 to the first memory unit 33 in response to a power down signal PDS output from the host 20 (S41).

The first memory unit 33 stores the system data S-data (S43) and the controller 31 transmits a power down response signal PDRS to the host 20 when the system data are completely stored in the first memory unit 33 (S45). The host 20 shuts off a power supplied to the controller 31 in response to the power down signal PDS.

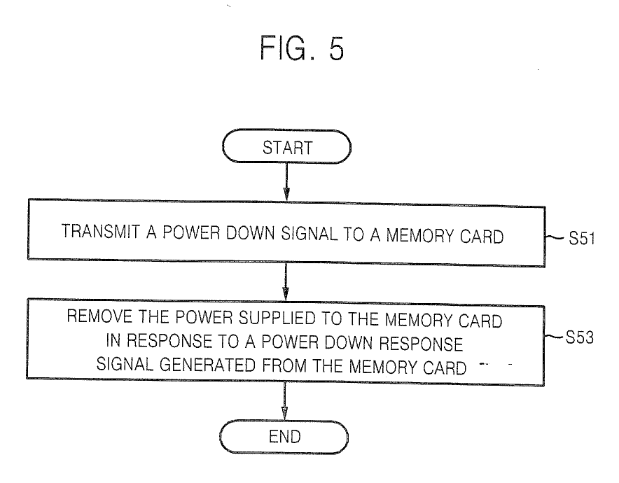

FIG. 5 is a flow chart illustrating a power down method of electric devices according to example embodiments of the present invention. Referring to FIGS. 1 and 5, the electric product, e.g., the host 20, transmits a power down signal PDS to the memory card 30 before powering down. (S51) The electric product 20 removes a power VCC supplied to the memory card 30 in response to a power down response signal PDRS generated by the memory card 30. (S53)

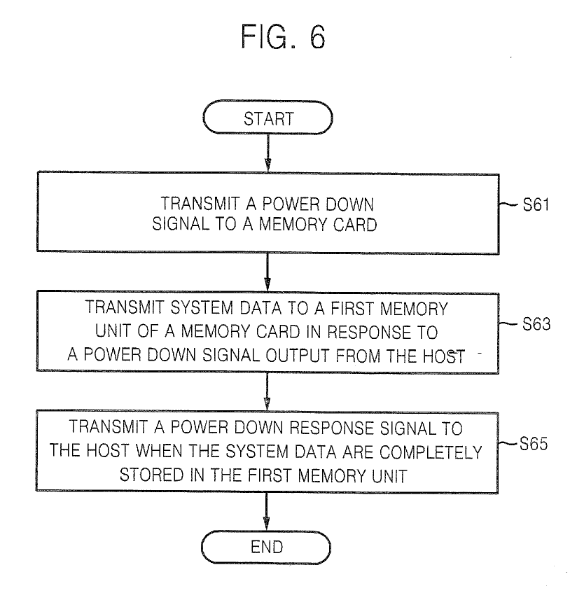

FIG. 6 is a flow chart illustrating a power down method of the electric system according to example embodiments of the present invention. Referring to FIGS. 1 and 6, a host 20 transmits a power down signal PDS to the memory card 30 during powering down. (S61) The CPU 31-1 of the memory card 30 transmits system data S-data to the first memory unit 33 of the memory card 30 in response to a power down signal PDS output from the host 20. (S63) The CPU 31-1 transmits a power down response signal PDRS to the host 20 when the system data S-data are completely stored in the first memory unit 33 (S65), and the host 20 shuts off a power supplied to the controller 31.

As described above, a semiconductor memory device and a power down method thereof according to the present invention may store safely system data generated in the semiconductor memory device, since having a power supplied to the semiconductor memory device not being powered down until a power down response signal occurs.

Also, a controller of a memory card according to the present invention uses an additional first memory unit when storing system data and stores the system data in a second memory unit when closing the system, so that it may reduce the total data storage time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed:

1. A method of operating a storage device, the method comprising transferring system data generated by a controller circuit, in the storage device, to a non-volatile memory unit, in the storage device, responsive to a power down signal received from a host outside the storage device and power down response signal transmitted by the storage device.

2. A method according to claim 1 wherein transferring further comprises:
transmitting the system data generated based on user data, received from the host, to the non-volatile volatile memory unit in response to the power down signal received from the host; and
transmitting the power down response signal from the controller circuit to the host upon completion of transmitting the system data to the non-volatile volatile memory unit.

3. A method according to claim 1 the method further comprising:
storing the system data in a volatile memory unit that is separate from the non-volatile volatile memory unit;
storing the user data in the non-volatile memory unit; and then
transferring the system data from the volatile memory unit to the non-volatile memory unit responsive to the power down signal received from the host.

4. A method according to claim 2 further comprising:
removing power provided by the host from the storage device responsive to the power down response signal.

5. A method according to claim 2 wherein transmitting the system data comprises:
transferring the system data from the volatile memory unit to the non-volatile memory unit through the controller circuit.

6. A method according to claim 2 wherein transmitting the system data comprises:
transferring the system data from the volatile memory unit directly to the non-volatile memory unit.

7. A method according to claim 1 wherein transferring further comprises:
receiving power down signal at the controller circuit;
transferring the system data from a volatile memory unit to the non-volatile memory unit responsive to the power down signal;
transmitting a signal to the controller circuit upon completion of transferring the system data;
transmitting the power down response signal from the controller circuit to the host upon receipt of the signal; and
removing power provided by the host from the storage device responsive to transmitting the power down response signal.

8. A method of operating a memory card using a remote host, the method comprising:
transmitting a power down signal to the memory card; and then
removing power to the memory card in response to a power down response signal received from the memory card.

9. A semiconductor memory device comprising:
a volatile memory unit configured to store system data during operation of the semiconductor memory device;
a CPU, connected to the volatile memory unit and configured to generate a system data storage control signal in response to a power down signal received from a host; and
a data control circuit, connected to the CPU, and configured to transfer the system data from the volatile memory unit to a non-volatile memory unit responsive to the data storage control signal, wherein the CPU transmits a power down response signal to the host upon completion of transferring the system data to the non-volatile memory unit.

10. The semiconductor memory device of claim 9, wherein the CPU is configured to generate the system data based on user data received from the host, and is configured to store the system data in the volatile memory unit.

11. A semiconductor memory device comprising:
a non-volatile memory unit; and
a controller circuit, connected to the non-volatile memory unit, and configured to transfer system data to the non-volatile memory unit in response to a power down signal received from a host, wherein the controller circuit transmits a power down response signal to the host upon completion of transferring the system data to the non-volatile memory unit.

12. The semiconductor memory device of claim 11, wherein the controller circuit comprises:
a volatile memory unit configured to store the system data;
a CPU, connected to the volatile memory unit, and configured to generate a system data storage control signal in response to the power down signal received from the host;
a data control circuit, connected to the CPU, and configured to transfer the system data from the volatile memory unit to the non-volatile memory unit based on the system data storage control signal, wherein the CPU transmits the power down response signal to the host upon completion of transferring the system data to the non-volatile memory unit.

13. The semiconductor memory device of claim 12, wherein the CPU is configured to generate the system data based on user data received from the host, and is configured to store the system data in the volatile memory unit during operation of the semiconductor memory device prior to powering down.

14. An electric device comprising:
a host control unit configured to control data input/output to/from a memory card coupled thereto, and configured to transmit a power down signal to the memory card; and
a power controller circuit configured to selectively provide power to the memory card, wherein the host control unit is configured to transmit a power down control signal to the power controller circuit in response to a power down response signal received from the memory card after transmission of the power down signal, wherein the power controller circuit is further configured to remove power from the memory card responsive to the power down control signal.

15. A power down method of an electric system, the method comprising:
transmitting a power down signal from a host to a memory card;
storing system data in a non-volatile memory unit in response to the power down signal from the host;
transmitting a power down response signal to the host upon completion of storing the system data in the non-volatile memory unit; and
removing power supplied to the memory card based on the power down response signal.

16. The method of claim 15, wherein the system data is generated in the memory card based on user data received from the host, and stored in a volatile memory unit of the memory card during operations prior to power-down of the memory card.
